(19) United States
(12) Patent Application Publication
(10) Pub. No.: US 2025/0086815 A1
(43) Pub. Date: Mar. 13, 2025

(54) IMAGE PROCESSING DEVICE, IMAGE PROCESSING METHOD, AND PROGRAM

(71) Applicants: HONDA MOTOR CO., LTD., Minato-ku, Tokyo (JP); Toho University, Ota-ku, Tokyo (JP)

(72) Inventors: Takamasa Koshizen, Wako-shi (JP); Fumiaki Sato, Funabashi-shi (JP)

(21) Appl. No.: 18/728,087

(22) PCT Filed: Jan. 27, 2023
(86) PCT No.: PCT/JP2023/002743

§ 371 Date: Jul. 11, 2024

(30) Foreign Application Priority Data
Jan. 31, 2022 (JP) 2022-013414

(51) Int. Cl. G06T 7/536; G06T 7/11; G06T 7/73; G06T 11/00; G06V 20/58

(52) U.S. Cl. CPC G06T 7/536; G06T 7/11; G06T 7/73; G06T 11/00; G06T 2207/30261; G06V 20/58; G06V 2201/08

(57) ABSTRACT

An image processing device includes an object detection portion detecting an object in an image captured in a substantially horizontal direction by an image sensor; a distance estimation portion estimating, when the detected object is a vehicle, a distance between the vehicle and the image sensor; a virtual line drawing portion drawing a virtual line extending in a lateral direction of the image at a position at the same height as an upper end of the vehicle in the image; a segmentation execution portion executing segmentation processing of extracting a road region in which the vehicle is traveling from the image when the estimated distance is shorter than a threshold; and a vanishing point determination portion determining a height position of a vanishing point in the image on the basis of the virtual line when the estimated distance is equal to or longer than the threshold and determining the height position of the vanishing point on the basis of the extracted road region when the estimated distance is shorter than the threshold.

### TECHNICAL FIELD

The present invention relates to an image processing device, an image processing method, and a program.

### BACKGROUND ART

In the related art, a technology of extracting a vanishing point from an image captured by a camera mounted in a vehicle is known. For example, Patent Document 1 discloses a technology of calculating a motion vector from a plurality of images captured by a camera and obtaining vanishing point coordinates in an image using the calculated motion vector.

### CITATION LIST

### Patent Document

### [Patent Document 1]

Japanese Unexamined Patent Application, First Publication No. 2012-123751

### SUMMARY OF INVENTION

### Technical Problem

In the technology described in Patent Document 1, a motion vector is calculated for each pixel from a plurality of images captured by a camera using a block matching method, a gradient method, or the like. However, such a technology in the related art may incur a very large calculation cost in order to improve the accuracy of a vanishing point.

The present invention has been made in consideration of such circumstances, and an object thereof is to provide an image processing device, an image processing method, and a program capable of obtaining a vanishing point with high accuracy while maintaining a low calculation cost.

### Solution to Problem

An image processing device, an image processing method, and a program according to this invention employ the following constitutions.
(1): An image processing device according to an aspect of this invention includes an object detection portion detecting an object in an image captured in a substantially horizontal direction by an image sensor: a distance estimation portion estimating, when the detected object is a vehicle, a distance between the vehicle and the image sensor; a virtual line drawing portion drawing a virtual line extending in a lateral direction of the image at a position at the same height as an upper end of the vehicle in the image: a segmentation execution portion executing segmentation processing of extracting a road region in which the vehicle is traveling from the image when the estimated distance is shorter than a threshold; and a vanishing point determination portion determining a height position of a vanishing point in the image on the basis of the virtual line when the estimated distance is equal to or longer than the threshold and determining the height position of the vanishing point on the basis of the extracted road region when the estimated distance is shorter than the threshold.
(2): According to the aspect of the foregoing (1), at least the distance estimation portion and the vanishing point determination portion repeatedly and synchronously perform processing for each control cycle, and the distance estimation portion estimates the distance in a current control cycle using the height position of the vanishing point determined by the vanishing point determination portion in a previous control cycle.
(3): According to the aspect of the foregoing (1) or (2), at least the distance estimation portion and the vanishing point determination portion repeatedly and synchronously perform processing for each control cycle, and the distance estimation portion estimates the distance in a current control cycle using the height position of the vanishing point determined by the vanishing point determination portion in a previous control cycle.
(4): According to the aspect of the foregoing (3), the learned model is taught to output a vehicle in the image as a region indicating the road region.
(5): According to the aspect of any one of the foregoing (1) to (4), the vanishing point determination portion determines a position of the virtual line shifted downward by a predetermined distance as the height position of the vanishing point when the estimated distance is equal to or longer than the threshold.
(6): According to the aspect of any one of the foregoing (1) to (5), when a plurality of the vehicles of which the estimated distance is equal to or longer than the threshold are present, the vanishing point determination portion shifts down a plurality of the virtual lines corresponding to the plurality of the vehicles by a predetermined distance and determines an averaged position as the height position of the vanishing point.
(7): According to the aspect of any one of the foregoing (1) to (6), the image processing device further includes a bird's-eye view generation portion generating a bird's-eye view including the detected object from the image on the basis of the determined height position of the vanishing point. The bird's-eye view generation portion causes a display unit of the image processing device to display the generated bird's-eye view.
(8): An image processing method according to another aspect of this invention has a computer detecting an object in an image captured in a substantially horizontal direction by an image sensor: estimating, when the detected object is a vehicle, a distance between the vehicle and the image sensor; drawing a virtual line extending in a lateral direction of the image at a position at the same height as an upper end of the vehicle in the image: executing segmentation processing of extracting a road region in which the vehicle is traveling from the image when the estimated distance is shorter than a threshold; and determining a height position of a vanishing point in the image on the basis of the virtual line when the estimated distance is equal to or longer than the threshold and determining the height position of the vanishing point on the basis of the extracted road region when the estimated distance is shorter than the threshold.
(9): A program according to another aspect of this invention causes a computer to detect an object in an image captured in a substantially horizontal direction by an image sensor: to estimate, when the detected object is a vehicle, a distance between the vehicle and the image sensor; to draw a virtual line extending in a lateral direction of the image at a position at the same height as an upper end of the vehicle in the image; to execute segmentation processing of extracting a road region in which the vehicle is traveling from the image when the estimated distance is shorter than a threshold; and to determine a height position of a vanishing point in the image on the basis of the virtual line when the estimated distance is equal to or longer than the threshold and determine the height position of the vanishing point on the basis of the extracted road region when the estimated distance is shorter than the threshold.

### Advantageous Effects of Invention

According to the aspects (1) to (9), it is possible to obtain a vanishing point with high accuracy while maintaining a low calculation cost.

### BRIEF DESCRIPTION OF DRAWINGS

FIG. 1 is a view showing an example of a usage environment of a terminal device 100 mounted in a host vehicle M.

FIG. 2 is a view showing an example of a constitution of the terminal device 100.

FIG. 3 is a view showing an example of a scene in which a distance estimation portion 120 estimates a distance between the host vehicle M and a surrounding vehicle M1.

FIG. 4 is an explanatory view of a method in which the distance estimation portion 120 estimates the distance between the host vehicle M and the surrounding vehicle M1 in a vertical direction.

FIG. 5 is an explanatory view of a method in which the distance estimation portion 120 estimates the distance between the host vehicle M and the surrounding vehicle M1 in a lateral direction.

FIG. 6 is a view showing an example of a bird's-eye view and a camera image displayed in a display unit 20.

FIG. 7 is a view showing another example of a bird's-eye view and a camera image displayed in the display unit 20.

FIG. 8 is an explanatory view of a first method for determining a vanishing point V according to the present embodiment.

FIG. 9 is an explanatory view of a second method for determining the vanishing point V according to the present embodiment.

FIG. 10 is a flowchart showing an example of a flow of processing executed by a bird's-eye view application.

### DESCRIPTION OF EMBODIMENT

Hereinafter, an embodiment of an image processing device, an image processing method, and a program according to the present invention will be described with reference to the drawings. In the present embodiment, for example, the image processing device is a terminal device 100 such as a smartphone having a camera (image sensor) and a display (display unit). However, the present invention is not limited to such a constitution, and the image processing device need only be a computer device having at least a computation function excluding the camera and the display from the constitution of the terminal device 100, which will be described below. In such a case, functions of the present invention are realized by a camera, a display, and an image processing device in cooperation.

### [Constitution]

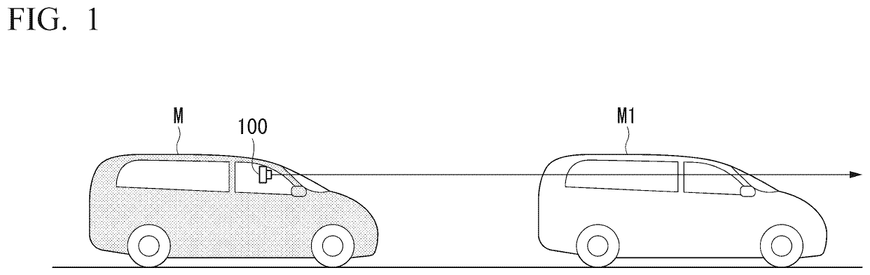

FIG. 1 is a view showing an example of a usage environment of the terminal device 100 mounted in a host vehicle M. For example, the host vehicle M is a vehicle having two wheels, three wheels, four wheels, or the like, and a drive source thereof is an internal-combustion engine such as a diesel engine or a gasoline engine, an electric motor, or a combination of these. The electric motor operates using power generated by a generator coupled to the internal-combustion engine or discharge power of a secondary battery or a fuel cell.

As shown in FIG. 1, the terminal device 100 is installed in the host vehicle M such that images of a region in front of the host vehicle M in a traveling direction can be captured. For example, the terminal device 100 is held by an in-car holder (not shown) attached to a dashboard of the host vehicle M and captures images of the region in front of the host vehicle M. As will be described below, a user of the terminal device 100 positionally sets the terminal device 100 at a predetermined height in accordance with a guide line displayed in a display unit 20. FIG. 1 shows a situation, as a result of the positionally set terminal device 100, in which images of a part in the vicinity of an upper end of a surrounding vehicle M1 of the host vehicle M are being captured in a substantially horizontal direction with respect to a road surface.

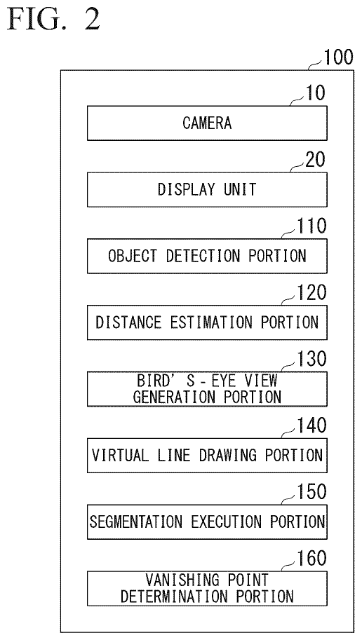

FIG. 2 is a view showing an example of a constitution of the terminal device 100. As shown in FIG. 2, for example, the terminal device 100 includes a camera 10, the display unit 20, an object detection portion 110, a distance estimation portion 120, a bird's-eye view generation portion 130, a virtual line drawing portion 140, a segmentation execution portion 150, and a vanishing point determination portion 160.

The object detection portion 110, the distance estimation portion 120, the bird's-eye view generation portion 130, the virtual line drawing portion 140, the segmentation execution portion 150, and the vanishing point determination portion 160 are realized, for example, by a hardware processor such as a central processing unit (CPU) executing a program (software). Some or all of these constituent elements may be realized by hardware (circuit portion; including circuitry) such as a large scale integration (LSI), an application specific integrated circuit (ASIC), a field-programmable gate array (FPGA), or a graphics processing unit (GPU), or may be realized by software and hardware in cooperation. A program may be stored in advance in a storage device (a storage device including a non-transitory storage medium) such as a hard disk drive (HDD) or a flash memory or may be stored in an attachable/detachable storage medium (non-transitory storage medium) such as a DVD or a CD-ROM such that the program is installed when the storage medium is mounted in a drive device. In the following description, functions of the object detection portion 110, the distance estimation portion 120, the bird's-eye view generation portion 130, the virtual line drawing portion 140, the segmentation execution portion 150, and the vanishing point determination portion 160 may be collectively referred to as “a bird's-eye view application”. The bird's-eye view application is mounted in the terminal device 100 and is started, for example, when a user of the terminal device 100 starts driving of the host vehicle M. For example, the camera 10 is a digital camera utilizing a solid-state image capturing element such as a charge coupled device (CCD) or a complementary metal oxide semiconductor (CMOS). For example, the display unit is a display device such as a touch panel or a liquid crystal display.

### [Estimation of Distance]

The object detection portion 110 detects an object taken in an image captured by the camera 10. More specifically, for example, if an image captured by the camera 10 is input, the object detection portion 110 detects an object using a learned model which has been taught to output information such as the presence, the position, the kind, and the like of an object. For example, the object detection portion 110 can detect the presence and the position of a vehicle, and the presence and the position of road marking lines using this learned model.

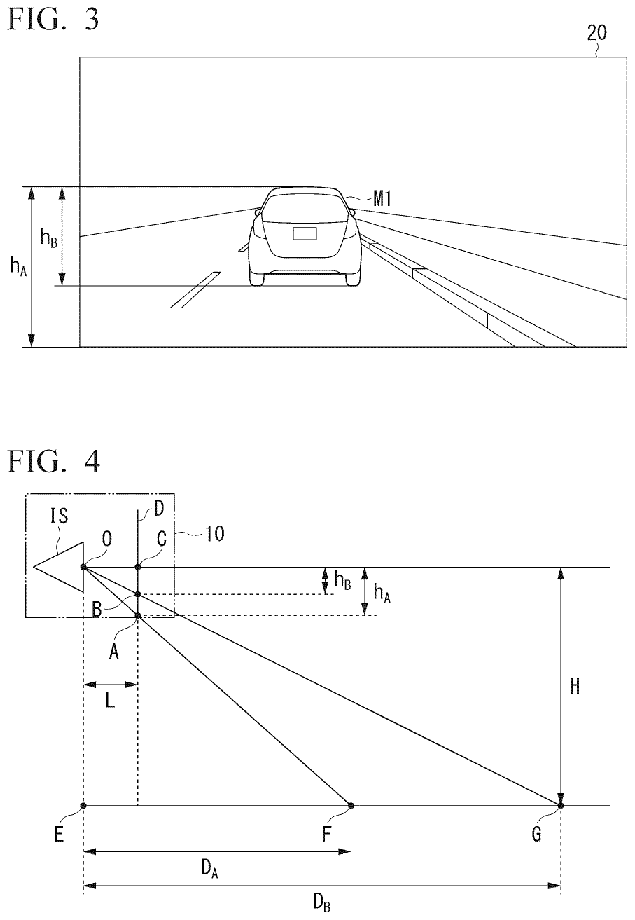

When an object detected by the object detection portion 110 is a vehicle (in this case, a vehicle denotes a vehicle having two wheels, three wheels, four wheels, or the like), the distance estimation portion 120 estimates a distance between a detected vehicle and the camera 10. FIG. 3 is a view showing an example of a scene in which the distance estimation portion 120 estimates a distance between the host vehicle M and the surrounding vehicle M1. In FIG. 3, the reference sign hA indicates a height from a road position corresponding to a lower end of the display unit 20 to a vanishing point in an image, and the reference sign hB indicates a height from a road position corresponding to a lower end of the detected surrounding vehicle M1 to the vanishing point in the image. A method for determining a vanishing point will be described below.

FIG. 4 is an explanatory view of a method in which the distance estimation portion 120 estimates the distance between the host vehicle M and the surrounding vehicle M1 in a vertical direction. In FIG. 4, the reference sign IS indicates the image sensor included in the camera 10. The reference sign D indicates the display (an end portion of the camera 10) included in the camera 10. The reference sign O indicates a central portion of the image sensor. The reference sign A indicates a position on the display D corresponding to a road position F taken in a bottom portion of the display D.

The reference sign B indicates a position on the display D corresponding to a road position G of a rear end portion of the surrounding vehicle M1. The reference sign C indicates an intersection between an image capturing direction of the image sensor and the display D. The reference sign H indicates the height of the camera 10 based on the road surface. The reference sign DA indicates a distance from the position of the image sensor IS to the road position F taken in the bottom portion of the display D. The reference sign DB indicates a distance from the position of the image sensor IS to the road position G of the rear end portion of the surrounding vehicle M1.

In FIG. 4, a triangle OAC and a triangle OEF are in similitude, and a triangle OBC and a triangle OEG are in similitude. That is, regarding the distance, since L:hA=DA:H and L:hB=DB:H are established, DA=L×H/hA and DB=L×H/hB are obtained by transformation. Therefore, the distance estimation portion 120 can calculate the distance to the road position G of the rear end portion of the surrounding vehicle M1 using a calculation formula DB=DA×hA/hB. Here, the heights hA and hB to the vanishing point can be calculated in advance on the basis of an image captured by the camera 10, and the distance DA which does not depend on the position of the surrounding vehicle M1 can be calculated in advance in accordance with an installation position of the terminal device 100. The foregoing calculation can be executed by simply using height information of the vanishing point without requiring all coordinates information of the vanishing point.

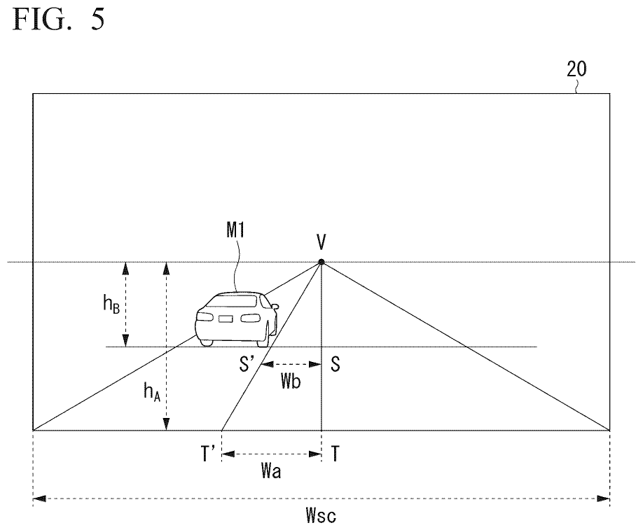

When an object detected by the object detection portion 110 is a vehicle, the distance estimation portion 120 further estimates the distance to a detected vehicle in a lateral direction. FIG. 5 is an explanatory view of a method in which the distance estimation portion 120 estimates the distance to the surrounding vehicle M1 in the lateral direction. In FIG. 5, the reference sign V indicates a vanishing point in an image. The reference sign Wb indicates the number of pixels in the lateral direction based on the vanishing point V of the surrounding vehicle M1. The reference sign Wa indicates the number of pixels when the number of pixels Wb are moved to the lowermost end of the display D.

In FIG. 5, a triangle VT′T and a triangle VS'S are in similitude. That is, regarding the distance, since Wa:hA==Wb:hB is established, Wa=Wb×hA/hB is obtained by transformation. Here, on the assumption that a total number of pixels Wsc at the lower end of the display D and a road width Wrd for the traveling host vehicle M are already known, the distance estimation portion 120 can calculate an actual distance W in the lateral direction corresponding to the number of pixels Wa using a calculation formula W=Wrd×Wa/Wsc. As above, the distance estimation portion 120 calculates the distance between the host vehicle M and the surrounding vehicle M1 in the vertical direction and the distance therebetween in the lateral direction.

### [Generation of Bird's-Eye View]

The bird's-eye view generation portion 130 generates a bird's-eye view showing surrounding circumstances of the host vehicle M on the basis of the distance between the host vehicle M and the surrounding vehicle M1 in the vertical direction and the distance therebetween in the lateral direction estimated by the distance estimation portion 120. The bird's-eye view generation portion 130 causes the display unit 20 to display the generated bird's-eye view together with a camera image captured by the camera 10.

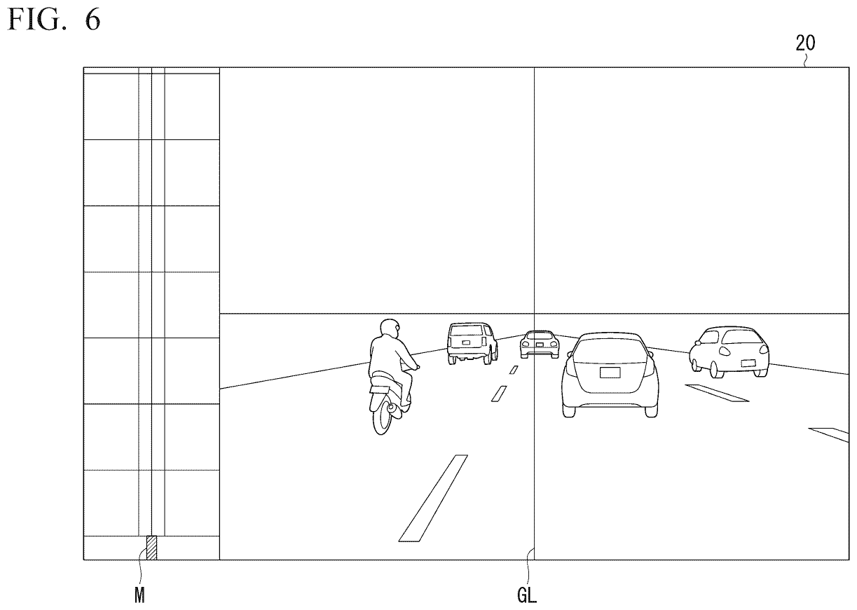

FIG. 6 is a view showing an example of a bird's-eye view and a camera image displayed in the display unit 20. The left part of FIG. 6 shows a bird's-eye view, and the right part of FIG. 6 shows a camera image. In FIG. 6, the reference sign GL indicates a guide line for a user setting the position of the terminal device 100 when the bird's-eye view application is started (or when the host vehicle M starts to move). A user installs the terminal device 100 inside the vehicle such that the intersection of the displayed guide line matches the vanishing point (that is, a point where the road is lost to sight). The intersection set at this time is read by the bird's-eye view application as an initial value of the vanishing point. FIG. 6 shows an example in which only the host vehicle M is displayed in the bird's-eye view immediately after the bird's-eye view application is started.

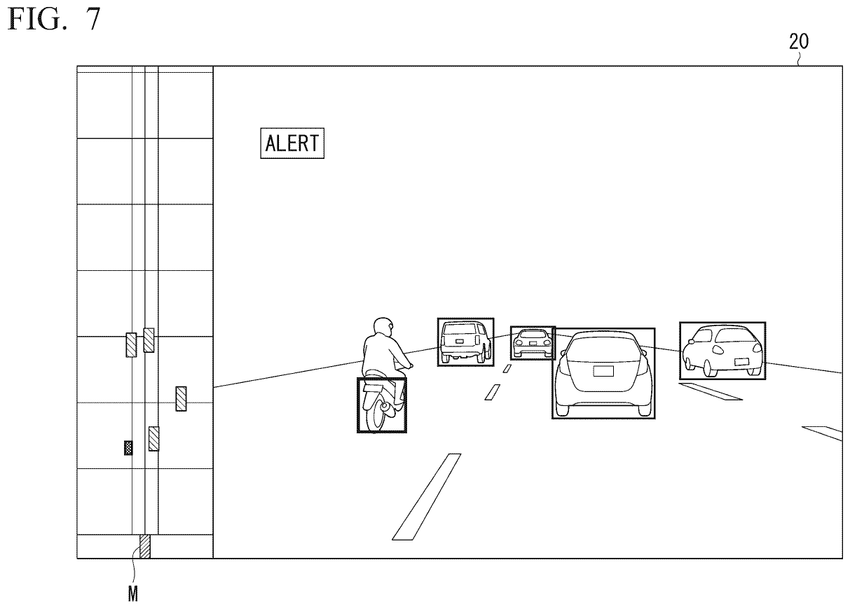

FIG. 7 is a view showing another example of a bird's-eye view and a camera image displayed in the display unit 20. FIG. 7 shows an example in which the distance estimation portion 120 estimates the distance in the vertical direction and the distance in the lateral direction based on the host vehicle M regarding four surrounding vehicles and one motorcycle detected by the object detection portion 110 and the bird's-eye view generation portion 130 generates a bird's-eye view on the basis of the estimated distances. As shown in the left part of FIG. 7, a driver of the host vehicle M can more reliably recognize vehicles around the host vehicle M by referring to the bird's-eye view and can utilize this for his/her driving.

### [Determination of Vanishing Point]

As described above, in estimating the distance between the host vehicle M and a surrounding vehicle, the vanishing point in an image captured by the camera 10 is utilized. A user determines the vanishing point using a guide line immediately after the bird's-eye view application is started, but if the host vehicle M starts traveling, the vanishing point in an image can be changed in accordance with the circumstances of the road surface, for example. Therefore, in order to accurately estimate the distance between the host vehicle M and a surrounding vehicle and generate a bird's-eye view, it is required to accurately determine the vanishing point. Hereinafter, a method for determining a vanishing point in the present embodiment will be described.

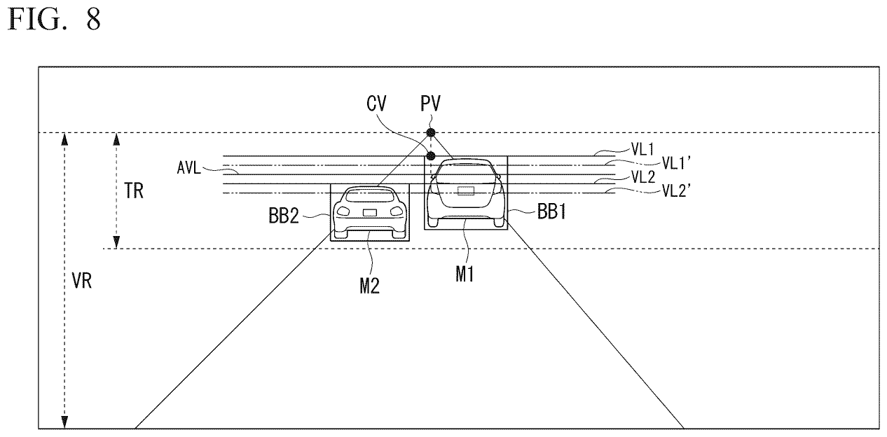

FIG. 8 is an explanatory view of a first method for determining the vanishing point V according to the present embodiment. In FIG. 8, the reference sign VR indicates a virtual road region in a camera image. The reference sign TR indicates a target region as a partial region of the virtual road region. More specifically, the virtual road region VR is a rectangular region of a range from the lower end of the camera image to the height position of the vanishing point, and the target region TR is a region corresponding to a range from an upper end of the virtual road region VR in a predetermined ratio. Moreover, the reference sign PV indicates a vanishing point in calculated in a previous control cycle. The reference sign CV indicates a vanishing point calculated in a current control cycle.

If a surrounding vehicle is detected by the object detection portion 110, the virtual line drawing portion 140 first sets a bounding box BB surrounding the detected surrounding vehicle. In the case of FIG. 8, as an example, the virtual line drawing portion 140 sets a bounding box BB1 for the surrounding vehicle M1 and sets a bounding box BB2 for a surrounding vehicle M2.

The virtual line drawing portion 140 further draws a virtual line VL extending in the lateral direction of the image at a position at the same height as the upper end of the surrounding vehicle in which the bounding box BB is set (the upper end of the bounding box BB). In the case of FIG. 8, the virtual line drawing portion 140 draws a virtual line VL1 corresponding to the surrounding vehicle M1 and a virtual line VL2 corresponding to the surrounding vehicle M2.

Next, the vanishing point determination portion 160 judges whether or not there are a predetermined number or more of surrounding vehicles present in the target region TR (in other words, whether or not there are a predetermined number or more of surrounding vehicles of which the distance in the vertical direction estimated by the distance estimation portion 120 is equal to or longer than a predetermined distance). When it is judged that there are a predetermined number or more of surrounding vehicles present in the target region TR, the vanishing point determination portion 160 obtains new virtual lines VL′ by shifting down the virtual lines VL by certain distances. In the case of FIG. 8, the virtual line drawing portion 140 obtains a virtual line VL1′ by shifting down the virtual line VL1 corresponding to the surrounding vehicle M1 by a certain distance and obtains a virtual line VL2′ by shifting down the virtual line VL2 corresponding to the surrounding vehicle M2 by a certain distance.

Next, the vanishing point determination portion 160 obtains an average virtual line AVL by calculating the average value of the new virtual lines VL′. The vanishing point determination portion 160 determines the weighting average value between the previous vanishing point PV and the average virtual line AVL as the current vanishing point CV. In this manner, in the present embodiment, the new virtual lines VL′ obtained by shifting down the virtual lines VL drawn across the surrounding vehicles present in the target region TR by certain distances are determined as the height positions of the vanishing points. Moreover, the average value of the new virtual lines VL′ is calculated for the plurality of surrounding vehicles present in the target region TR, and the current vanishing point CV is determined with high accuracy by obtaining the weighting average value with respect to the previous vanishing point PV. Through the foregoing processing, the vanishing point determination portion 160 can calculate the vanishing point with high accuracy by simpler calculation without using a technique such as machine learning requiring high calculation cost.

The method for determining the vanishing point V described with reference to FIG. 8 is executed when there are a predetermined number or more of surrounding vehicles in the target region TR of the virtual road region VR. However, there may not be a predetermined number or more of surrounding vehicles present in the target region TR depending on traffic circumstances of the road, or the field of view of the camera 10 may be obstructed due to a surrounding vehicle present in a nearby region in front of the host vehicle M (that is, a region excluding the target region TR from the virtual road region VR). In such a case, it may not be possible to determine the vanishing point V using the method described above. Therefore, when there are not a predetermined number or more of surrounding vehicles present in the target region TR, or when there is a surrounding vehicle in a nearby region in front of the host vehicle M so that the field of view of the camera 10 is obstructed, the vanishing point determination portion 160 determines the vanishing point V using a second determination method, which will be described below. It is possible to judge whether or not the field of view of the camera 10 is obstructed, for example, on the basis of whether or not the ratio of the area occupied by the surrounding vehicle in a nearby region in front of the host vehicle M shown in the camera image is equal to or higher than a predetermined value.

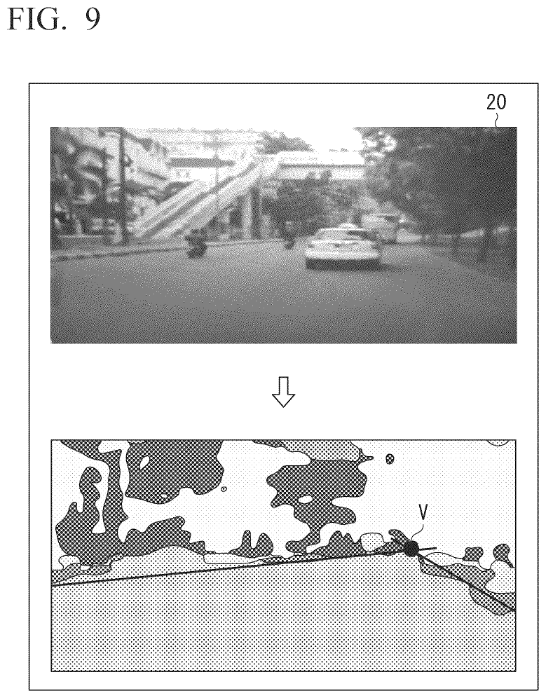

FIG. 9 is an explanatory view of a second method for determining the vanishing point V according to the present embodiment. The upper part of FIG. 9 shows a camera image, and the lower part of FIG. 9 shows a road region extracted by inputting a camera image to a learned model which has been taught to output a road region in the image if an image is input.

When there are not a predetermined number or more of surrounding vehicles present in the target region TR, or when the field of view of the camera 10 is obstructed, the segmentation execution portion 150 extracts a road region by inputting a camera image to a learned model which has been taught to output a road region in the image if an image is input. For example, such a learned model can be generated using a technique of semantic segmentation on the basis of learning data in which labeling is performed for pixels showing the road region. Learning data used at this time is data in which labeling is not performed for pixels showing vehicles (learning data not including the vehicle class). By using such learning data, a road region can be extracted in a simple shape.

If a road region is extracted by the segmentation execution portion 150, the vanishing point determination portion 160 applies left and right road boundary lines (straight lines) to the boundary of the extracted road region. For example, the left and right road boundary lines are decided by a least squares method. The vanishing point determination portion 160 determines the intersection of the decided left and right road boundary lines as the vanishing point V. In this manner, the vanishing point determination portion 160 determines the vanishing point V using either the first determination method or the second determination method in accordance with whether or not there are a predetermined number or more of surrounding vehicles in the target region TR and whether or not the field of view of the camera 10 is obstructed. Accordingly, the vanishing point V can be determined by an optimal method in accordance with traffic circumstances of the road.

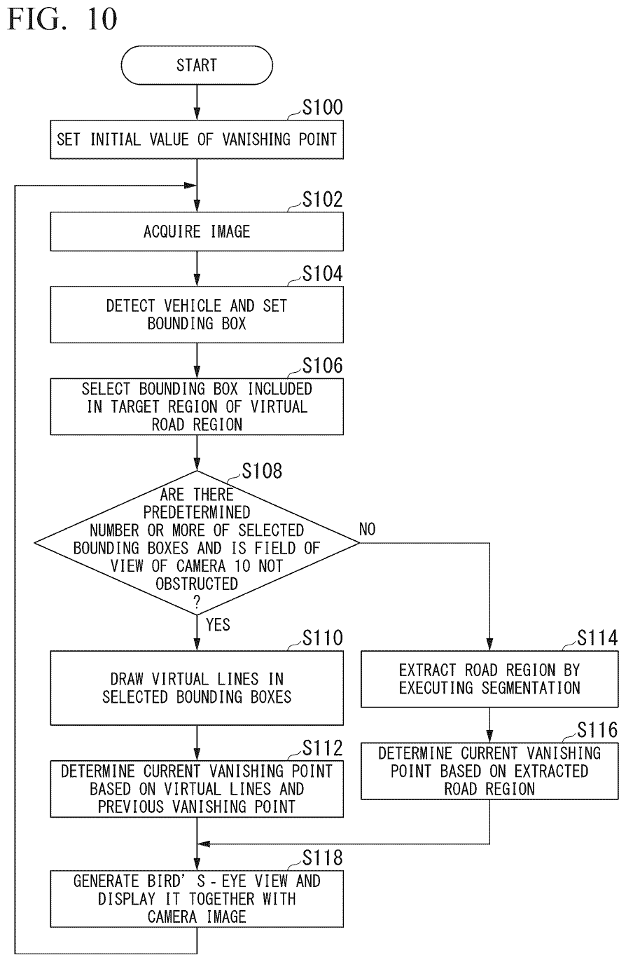

Next, a flow of processing executed by the bird's-eye view application will be described with reference to FIG. 10. FIG. 10 is a flowchart showing an example of a flow of processing executed by the bird's-eye view application. For example, processing of this flowchart is executed when the bird's-eye view application is started.

First, at the time of starting, the bird's-eye view application receives setting of an initial value of a vanishing point from a user (Step S100). Next, the bird's-eye view application acquires a camera image captured by the camera 10 (Step S102).

Next, the bird's-eye view application detects a surrounding vehicle in the camera image and sets the bounding box BB over the detected surrounding vehicle (Step S104). Next, the bird's-eye view application selects the bounding box included in the target region TR of the virtual road region VR (Step S106).

Next, the bird's-eye view application judges whether or not there are a predetermined number or more of bounding boxes included in the target region TR of the virtual road region VR (that is, a predetermined number or more of surrounding vehicles) and the field of view of the camera 10 is obstructed (Step S108).

When it is judged that there are a predetermined number or more of bounding boxes included in the target region TR of the virtual road region VR and the field of view of the camera 10 is not obstructed, the bird's-eye view application draws the virtual lines VL extending in the lateral direction of the image at positions at the same height as the upper ends of the selected bounding boxes (Step S110). Next, the bird's-eye view application acquires the new virtual lines VL′ by shifting down the virtual lines VL by certain distances respectively for a plurality of surrounding vehicles, calculates the average virtual line AVL of the new virtual lines VL′, and determines the weighting average value between the previous vanishing point PV and the average virtual line AVL as the current vanishing point CV (Step S112).

Meanwhile, when it is judged that there are not a predetermined number or more of bounding boxes included in the target region TR of the virtual road region VR or the field of view of the camera 10 is obstructed, the bird's-eye view application extracts a road region by executing segmentation of inputting a camera image to a learned model (Step S114). Next, the bird's-eye view application applies left and right road boundary lines to the extracted road region and determines the intersection thereof as the current vanishing point CV (Step S116).

If the current vanishing point CV is determined, the bird's-eye view application generates a bird's-eye view by estimating the distance between the host vehicle M and the surrounding vehicle on the basis of the current vanishing point CV and displays the generated bird's-eye view and the camera image together (Step S118). Thereafter, the processing of this flowchart returns to Step S102, and the current vanishing point CV is utilized as the previous vanishing point PV in the succeeding control cycle. For example, this processing is repeated until operation of the bird's-eye view application is halted or the host vehicle M stops.

According to the present embodiment described as above, the vanishing point determination portion 160 determines a vanishing point by selecting an optimal determination method between the first determination method and the second determination method in accordance with whether or not there are a predetermined number or more of surrounding vehicles in the target region TR of the virtual road region VR and whether or not the field of view of the camera 10 is obstructed. Accordingly, it is possible to obtain a vanishing point with high accuracy while maintaining a low calculation cost.

The foregoing embodiment described above can be expressed as follows.

An image processing device is constituted to include a storage device storing a program, and a hardware processor. The hardware processor executes the program stored in the storage device to detect an object in an image captured in a substantially horizontal direction by an image sensor; to estimate, when the detected object is a vehicle, a distance between the vehicle and the image sensor: to draw a virtual line extending in a lateral direction of the image at a position at the same height as an upper end of the vehicle in the image: to execute segmentation processing of extracting a road region in which the vehicle is traveling from the image when the estimated distance is shorter than a threshold; and to determine a height position of a vanishing point in the image on the basis of the virtual line when the estimated distance is equal to or longer than the threshold and determine the height position of the vanishing point on the basis of the extracted road region when the estimated distance is shorter than the threshold.

Hereinabove, forms for performing the present invention have been described using an embodiment. However, the present invention is not limited to such an embodiment in any way, and various modifications and replacements can be added within a range not departing from the gist of the present invention.

### REFERENCE SIGNS LIST

10 Camera
20 Display unit
100 Terminal device
110 Object detection portion
120 Distance estimation portion
130 Bird's-eye view generation portion
140 Virtual line drawing portion
150 Segmentation execution portion
160 Vanishing point determination portion

What is claim is:

1. An image processing device comprising:
an object detection portion detecting an object in an image captured in a substantially horizontal direction by an image sensor;
a distance estimation portion estimating, when the detected object is a vehicle, a distance between the vehicle and the image sensor;
a virtual line drawing portion drawing a virtual line extending in a lateral direction of the image at a position at the same height as an upper end of the vehicle in the image;
a segmentation execution portion executing segmentation processing of extracting a road region in which the vehicle is traveling from the image when the estimated distance is shorter than a threshold; and
a vanishing point determination portion determining a height position of a vanishing point in the image on the basis of the virtual line when the estimated distance is equal to or longer than the threshold and determining the height position of the vanishing point on the basis of the extracted road region when the estimated distance is shorter than the threshold.

2. The image processing device according to claim 1,
wherein at least the distance estimation portion and the vanishing point determination portion repeatedly and synchronously perform processing for each control cycle, and
the distance estimation portion estimates the distance in a current control cycle using the height position of the vanishing point determined by the vanishing point determination portion in a previous control cycle.

3. The image processing device according to claim 1,
wherein the segmentation execution portion extracts the road region by inputting the image to a learned model which has been taught to output the road region in the image if an image acquired by the image sensor is input.

4. The image processing device according to claim 3,
wherein the learned model is taught to output a vehicle in the image as a region indicating the road region.

5. The image processing device according to claim 1,
wherein the vanishing point determination portion determines a position of the virtual line shifted downward by a predetermined distance as the height position of the vanishing point when the estimated distance is equal to or longer than the threshold.

6. The image processing device according to claim 1,
wherein when a plurality of the vehicles of which the estimated distance is equal to or longer than the threshold are present, the vanishing point determination portion shifts down a plurality of the virtual lines corresponding to the plurality of the vehicles by a predetermined distance and determines an averaged position as the height position of the vanishing point.

7. The image processing device according to claim 1 further comprising:
a bird's-eye view generation portion generating a bird's-eye view including the detected object from the image at least on the basis of the determined height position of the vanishing point,
wherein the bird's-eye view generation portion causes a display unit of the image processing device to display the generated bird's-eye view.

8. An image processing method in which a computer
detects an object in an image captured in a substantially horizontal direction by an image sensor,
estimates, when the detected object is a vehicle, a distance between the vehicle and the image sensor,
draws a virtual line extending in a lateral direction of the image at a position at the same height as an upper end of the vehicle in the image,
executes segmentation processing of extracting a road region in which the vehicle is traveling from the image when the estimated distance is shorter than a threshold, and
determines a height position of a vanishing point in the image on the basis of the virtual line when the estimated distance is equal to or longer than the threshold and determines the height position of the vanishing point on the basis of the extracted road region when the estimated distance is shorter than the threshold.

9. A program causing a computer
to detect an object in an image captured in a substantially horizontal direction by an image sensor,
to estimate, when the detected object is a vehicle, a distance between the vehicle and the image sensor,
to draw a virtual line extending in a lateral direction of the image at a position at the same height as an upper end of the vehicle in the image,
to execute segmentation processing of extracting a road region in which the vehicle is traveling from the image when the estimated distance is shorter than a threshold, and
to determine a height position of a vanishing point in the image on the basis of the virtual line when the estimated distance is equal to or longer than the threshold and to determine the height position of the vanishing point on the basis of the extracted road region when the estimated distance is shorter than the threshold.
